(19) United States
(12) Patent Application Publication
(10) Pub. No.: US 2020/0140070 A1
(43) Pub. Date: May 7, 2020

(54) AERIAL VEHICLE

(71) Applicant: SkyMul Inc., Marietta, GA (US)

(72) Inventors: Eohan George, Marietta, GA (US); Stefan T. Posey, Austell, GA (US)

(21) Appl. No.: 16/546,895

(22) Filed: Aug. 21, 2019

Related U.S. Application Data
(60) Provisional application No. 62/720,918, filed on Aug. 21, 2018.

(51) Int. Cl. B64C 27/08; B64C 39/02

(52) U.S. Cl. CPC B64C 27/08; B64C 39/024; B64C 2201/14; B64C 2201/108; B64C 2201/126; B64C 2201/024

(57) ABSTRACT

Embodiments herein disclose an aerial vehicle (AV). The AV comprises a body and a propulsion system. The propulsion system includes at least one primary rotor placed at a center of the AV and one or more auxiliary rotors mounted at a distance from the center of the AV. The distance of the one or more auxiliary rotors from the center of the AV can vary. Each of the auxiliary rotor are mounted to the AV at an adjustable angle from the center rotor of the vehicle. By adjusting the angles, the amount of lateral force that each auxiliary rotor exerts in the vertical direction and the horizontal direction is changed. In this way, the AV can be caused to move about in the horizontal direction without changing the attitude or vertical position of the AV.

### CROSS-REFERENCE TO RELATED APPLICATIONS

This application claims priority to U.S. Provisional Patent Application Ser. No. 62/720918 filed on Aug. 21, 2018. The contents of which are hereby incorporated by reference in their entirety.

### STATEMENT REGARDING FEDERALLY SPONSORED RESEARCH OR DEVELOPMENT

This invention was made with government support under contract number FA8651-18-P-0049 awarded by the United States Air Force. The government has certain rights in the invention.

### BACKGROUND

An aerial vehicle (AV), commonly known as a drone, is an aircraft without a human pilot onboard. Some AVs may be controlled by a remote control of a pilot or operator on the ground. Unmanned aerial vehicles (UAVs) are a type of AV that is controlled autonomously by an onboard or remotely located computer. The AV commonly includes multiple, such as four or more, fixed rotors, driven by controllable electric motors, providing take-off, hover, and landing capabilities. Existing AVs includes both advantages and disadvantages in terms of take-off, hover, and landing capabilities with a high degree of freedom, cost, accuracy level, usage of the AV, reliability, maneuverability, endurance, size constraint, or the like. In existing systems, most common multirotor AVs utilize a change of attitude or a vertical position to change a horizontal position, even where no change is vertical position is desired. This results in slower response to commands to change the vehicle's position, since the vehicle has to change the attitude first before changing the horizontal position. This problem gets aggravated when the rotational inertia of the vehicle increases in comparison to the rotational jerk and acceleration that the propulsive elements can exert on the AV, which is common for larger aircrafts.

### SUMMARY

Embodiments herein disclose an aerial vehicle (AV). The AV comprises a body and a propulsion system. The propulsion system includes at least one primary rotor placed at a center of the AV and one or more auxiliary rotors mounted at a distance from the center of the AV. The distance of the one or more auxiliary rotors from the center of the AV can vary. Each of the auxiliary rotor are mounted to the AV at an adjustable angle from the center rotor of the vehicle. By adjusting the angles, the amount of lateral force that each auxiliary rotor exerts in the vertical direction and the horizontal direction is changed. In this way, the AV can be caused to move about in the horizonal direction without changing the attitude (e.g., pitch, roll, or yaw) or vertical position of the AV.

In an embodiment, an AV is provided. The AV includes a body and a propulsion system. The propulsion system includes: a primary rotor mounted at a center of the body; and a plurality of auxiliary rotors, wherein each auxiliary rotor is mounted on the body at a distance from the center of the body and at an angle with respect to the primary rotor.

Embodiments may include some or all of the following features. The angle for each auxiliary rotor may be adjustable or fixed. The distance for each auxiliary rotor may be adjustable or fixed. The propulsion system may further include a control system adapted to: change the angle of one or more of the auxiliary rotors to change a direction of movement of the aerial vehicle. The control system may be adapted to change the direction of movement of the aerial vehicle without changing the attitude of the aerial vehicle or increasing or decreasing an altitude of the vehicle. The propulsion system may further include a control system adapted to change a rotation speed of one or more of the auxiliary rotors to change a direction of movement of the aerial vehicle. The control system may be adapted to change the direction of movement of the aerial vehicle without changing the attitude of the aerial vehicle or increasing or decreasing an altitude of the aerial vehicle. The control system may be further adapted to control a roll, pitch, and yaw of the aerial vehicle using the plurality of auxiliary rotors. The control system may be further adapted to control an altitude or attitude of the aerial vehicle using the primary rotor. Each of the auxiliary rotors may be smaller than the primary rotor.

In an embodiment, an aerial vehicle is provided. The aerial vehicle includes a body and a propulsion system. The propulsion system includes: a first primary rotor mounted at a center of the body; a first plurality of auxiliary rotors; and a second plurality of auxiliary rotors. Each auxiliary rotor in the first plurality of auxiliary rotors is mounted on the body at a first angle with respect to the first primary rotor. Each auxiliary rotor in the second plurality of auxiliary rotors is mounted on the body at a second angle with respect to the first primary rotor.

Embodiments may include some or all of the following features. The first angle and the second angle may be different. The aerial vehicle may further include a second primary rotor mounted at the center of the body. The propulsion system may further include a control system adapted to change a direction of movement of the aerial vehicle using the first plurality of auxiliary rotors or the second plurality of auxiliary rotors. The control system may be adapted to change the direction of movement of the aerial vehicle without changing the attitude of the aerial vehicle or increasing or decreasing an altitude of the aerial vehicle. Each of the auxiliary rotors may be smaller than the primary rotor.

In an embodiment, an AV is provided. The AV includes a support structure; a first propulsion system mounted on a top of the support structure; and a second propulsion system mounted on a bottom of the support structure. The first rotation speed of the first propulsion system and a second rotation speed of the second propulsion system may be synchronized to control a sound of the aerial vehicle.

Embodiments may include some or all the following features. The first rotation speed of the first propulsion system and a second rotation speed of the second propulsion system may be synchronized to control a yaw of the aircraft. The system may further include a fixed stator vane arranged between the first propulsion system and the second propulsion system. The second propulsion system may cancel a drag torque of the first propulsion system. The first propulsion system may include a primary rotor mounted at a center of the first propulsion system; and a plurality of auxiliary rotors, wherein each auxiliary rotor is mounted on the first propulsion system at a distance from the center of the first propulsion system and at an angle with respect to the primary rotor. The first propulsion system may include a control system adapted to change the angle of one or more of the auxiliary rotors to change a direction of movement of the aerial vehicle. The control system may be adapted to change the direction of movement of the aerial vehicle without changing the attitude of the aerial vehicle or increasing or decreasing an altitude of the vehicle. The first propulsion system may further include a control system adapted to change a rotation speed of one or more of the auxiliary rotors to change a direction of movement of the aerial vehicle. The control system may be adapted to change the direction of movement of the aerial vehicle without changing the attitude of the aerial vehicle or increasing or decreasing an altitude of the aerial vehicle. The control system may be further adapted to control a roll, pitch, and yaw of the aerial vehicle using the plurality of auxiliary rotors.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The following detailed description of illustrative embodiments is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of side and top views of an exemplary AV;

FIG. 2 is an illustration of an exemplary AV;

FIG. 3-FIG. 7 are illustrations of side and top views of exemplary AVs;

FIG. 8 is an illustration of an exemplary AV including a slung load;

FIG. 9 is an illustration of an example AV with top and bottom propulsion systems;

FIG. 10 is an illustration of an example stator vane;

FIGS. 11a and FIG. 11b are illustrations of vertical thrust operation in different directions;

FIGS. 12a and 12b are illustrations of various forces that may be applied to a slung load;

FIGS. 13 and 14 are sequence diagrams illustrating various operations for stabilizing the slung load;

FIG. 15 is an illustration of an exemplary AV;

FIG. 16 is an illustration of an exemplary AV;

FIG. 17 is an illustration of an exemplary primary rotor 102 including a tilting means.

FIGS. 18-22 are illustrations of exemplary AVs.

FIG. 23 shows an exemplary computing environment in which example embodiments and aspects may be implemented.

### DESCRIPTION OF EXAMPLE EMBODIMENTS

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

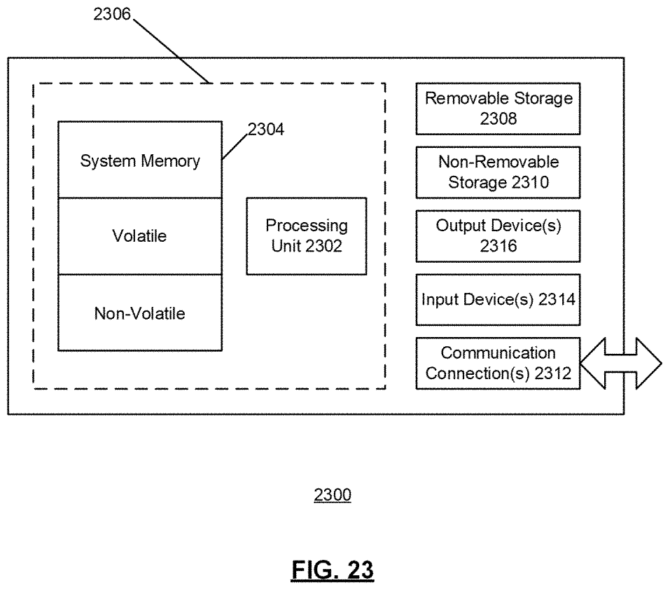

The embodiments herein disclose a system includes an aerial vehicle (AV) with/without a slung load. The AV may include a set of sensors and a control system. The slung load may also include a set of sensors and a control system. In an embodiment, the AV comprises a body and a propulsion system. The control systems may be implemented using a computing device such as the computing device 2300 illustrated with respect to FIG. 23.

The propulsion system may include at least one primary rotor placed at a center of the AV and one or more auxiliary rotors mounted at a variable distance from the center of the AV. The one or more auxiliary rotors exerts lateral forces for position control without tilting the entire AV, wherein lateral forces exerted by the one or more auxiliary rotors is varied in at least one of a vertical direction and a horizontal direction so that sustained side forces are exerted to move the AV in multiple directions.

In another embodiment, the AV comprises a support structure and a top propulsion system, mounted on the support structure, including one or more sensors. A bottom propulsion system, mounted on the support structure, and arranged in parallel to the top propulsion system. The bottom propulsion system includes one or more sensors. The top propulsion system and bottom propulsion system are synchronized to rotate at their individual RPMs such that the beat frequency (and the harmonics) can be controlled.

Beat frequency is often the manifestation of the difference of the frequencies of sounds produced by the individual blades. The individual RPMs and the beat frequencies are perceived as consonance or dissonance at varying loudness. The RPMs and their differences can be engineered to reduce the perception of loudness or the degree of consonance/dissonance with the intent to make the acoustic signature of the aircraft more comfortable.

In an embodiment, the top propulsion system includes at least one primary rotor placed at a center of the AV, and one or more auxiliary rotors mounted at a variable distance from the center of the AV. The one or more auxiliary rotors exerts lateral forces for position control without tilting the entire AV and wherein a ratio of lateral forces exerted by the one or more auxiliary rotors is varied in at least one of a vertical direction and a horizontal direction so that sustained side forces are exerted to move the AV in multiple directions. The at least one primary rotor and/or the one or more auxiliary rotors have a combined thrust vector that has a variable orientation with respect to the body of the AV. The at least one thrust component is utilized to control a change in movement of the AV with respect to a world coordinate system.

In an embodiment, the bottom propulsion system includes at least one primary rotor placed at a center of the AV, and one or more auxiliary rotors mounted at a variable distance from the center of the AV. The one or more auxiliary rotors exerts lateral forces for position control without tilting the entire AV and wherein a ratio of lateral forces exerted by the one or more auxiliary rotors is varied in at least one of a vertical direction and a horizontal direction so that sustained side forces are exerted to move the AV in multiple directions. The at least one primary rotor and/or the one or more auxiliary rotors have a combined thrust vector that has a variable orientation with respect to the body of the AV. The at least one thrust component is utilized to control a change in movement of the AV with respect to a world coordinate system.

In an embodiment, the movement comprises enabling changes in attitude and or position of the AV along with the slung load payload. In an embodiment, the movement comprises enabling changes in a position of the AV with respect to the world geographical location. In an embodiment, the movement comprises providing forces and moments to counteract external forces and moments experienced by the AV such as gravity, wind, touch etc. In an embodiment, the movement comprises enabling changes in the structure of the AV. In an embodiment, the movement comprises enabling changes in attitude of the AV which comprises primary and auxiliary rotors.

Unlike conventional systems, various configuration of a primary rotor and auxiliary rotors enable a compact AV with high payloads. The configuration of the primary rotor and the auxiliary rotors enable the AV to maneuver easily in the indoor environments for higher payloads or longer endurances. The various configuration of the primary rotor and the auxiliary rotors provide an ability to be at least partially resistant to obstacles with the blades which can be more easily protected than standard multi-rotors.

The AV described herein may be utilized for multiple applications in the same flight or a different flight. These applications may include transporting payloads while conducting survey missions of a region, building 3D maps of a region, and surveillance of a region. The AV configurations described herein provide the ability to control a slung load in presence of winds/gusts which is advantageous for outdoor environments and in presence of buildings/other obstacles etc.

Unlike conventional systems, the proposed AV has an improved aerodynamic propulsive efficiency. The proposed AV provides a set of primary rotors and auxiliary rotors configurations at the slung load that reduce the effort required for the AV to either reduce the effect of external disturbances such as wind and/or to accurately position the load with respect to the geographical coordinate system.

The proposed configuration provides a multirotor system which provides improved endurance and payload for a given size restriction. The configuration also provides the ability to change the position of the aircraft with little or no change in the attitude of the aircraft. One attribute or concept utilized to achieve this is the improved propulsive-efficiency/rotor-area of larger rotors versus smaller rotors.

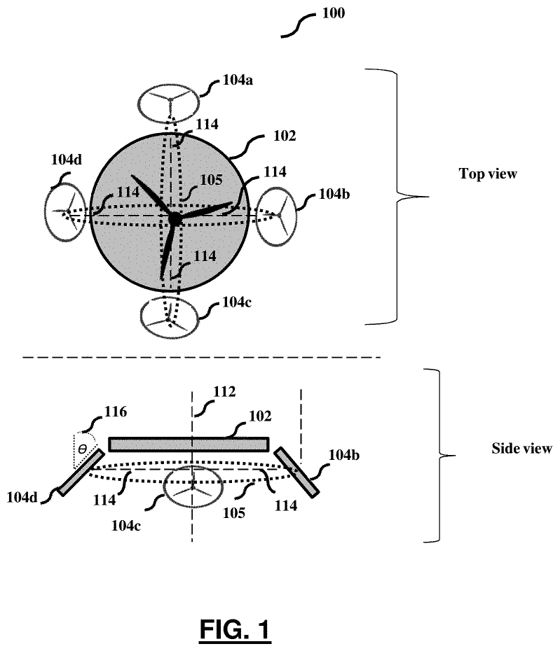

FIG. 1-FIG. 7 illustrate the AV 100, according to embodiments as disclosed herein. Various configurations of the AV 100 are depicted in FIGS. 1-7. The AV 100 can also be, for example but not limited to, an unmanned aircraft system, multi-rotor type small aircraft, a compact unmanned rotary aircraft, a quadcopter or the like.

With reference to FIG. 1, the AV 100 comprises a body 105 and a propulsion system. The propulsion system includes at least one primary rotor 102 mounted along a center line 112 of the body 105 of the AV 100 and one or more auxiliary rotors 104 each mounted on the body 105 at a distance 114 from the center line 112 in a direction that is perpendicular to the center line 112. Any method for mounting primary rotors 102 and auxiliary rotors 104 to a body 105 may be used. In FIG. 1 and the following figures the body 105 may be illustrated using dotted lines so that the locations of the various rotors 102 and 104 can be better appreciated.

The auxiliary rotors 104 can be located on the body 105 directly to the sides of primary rotors 102 as well as located above/below the primary rotor 102. In another embodiment, the one or more auxiliary rotors 104 are arranged at variable/configurable distances 114 from the primary rotor 102 on the body 105. The auxiliary rotors 104 are also referred to herein as rotors. The body 105 may also be referred to herein as a frame or support structure.

The auxiliary rotors 104 can be moveably mounted on a track on the body 105 such that a pilot or operator of AV 100 can selectively increase or decrease the distances 114 between each auxiliary rotor 104 and the primary rotor 102. In another embodiment, the body 105 may include telescoping arms that may be extended or retracted to selectively increase or decrease the distance 114 between each auxiliary rotor 104 and the primary rotor 102. Other methods for increasing or decreasing the distances 114 may be used. Alternatively, each auxiliary rotor 104 may be mounted to the body 104 at a fixed distance.

Each of the auxiliary rotors 104 are mounted to the body 105 of the AV 100 at an angle 116 with respect to the center line 112. The angle 116 may be adjustable or may be fixed. Depending on the embodiment, the pilot or operator of the AV 100 may manually adjust the angle 116 of each auxiliary rotor 104. For example, the pilot or operator may adjust one or more of the angles 116 while the AV 100 is on the ground.

Alternatively, or additionally, the pilot or operator of the AV 100 may adjust one or more of the angles 116 associated with the auxiliary rotors 104 while the AV 100 is inflight. For example, each auxiliary rotor 104 may have an associated motor that allows the angle 116 associated with the auxiliary rotor 104 to be changed (e.g., increased or decreased with respect to the center line 116).

The one or more auxiliary rotors 104 exert lateral forces for position control without tilting the entire AV 100, wherein the lateral forces exerted by the one or more auxiliary rotors 104 is varied in at least one of a vertical direction and a horizontal direction so that sustained side forces are exerted to move the AV 100 in multiple directions. As may be appreciated, the total amount of lateral forces exerted by an auxiliary rotor 104 may be increased or decreased by increasing or decreasing the speed of rotation of the auxiliary rotor. How the lateral forces exerted by an auxiliary rotor 104 is divided between the vertical direction and the horizontal direction may be controlled by adjusting the angle 116 between the rotors 104 and the center line 112. For example, if the angle 116 is zero degrees, the auxiliary rotor 104 may exert all of its force in the vertical direction. If the angle is 90 degrees, the auxiliary rotor 104 may exert all of its force in the horizontal direction.

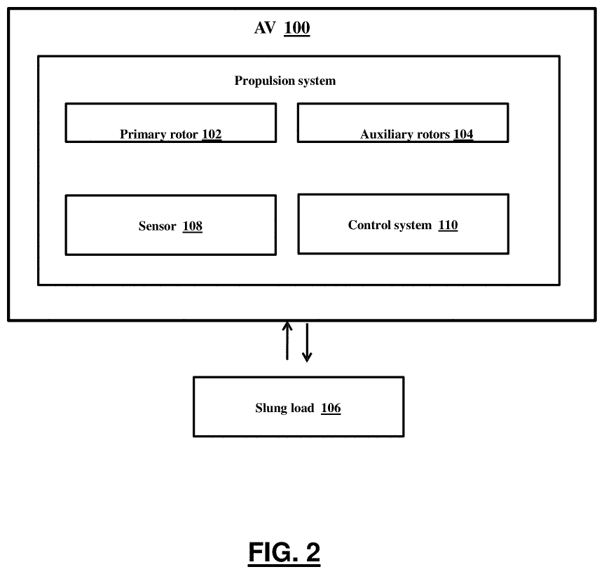

FIG. 2 is an illustration of various components of the AV 100. As shown the AV 100 includes a propulsion system that includes the primary rotor 102 and auxiliary rotors 104 described above. The propulsion system may further include one or more sensors 108 and a control system 110. The sensors 108 may include a variety of sensor types that may be used to aid the flight of the AV 100, as well as to collect various data for the pilot or operator of the AV 100. The sensors 108 may include cameras, accelerometers, GPS, altimeters, etc. Any type of sensor 108 may be used.

The control system 110 may control the various angles 116 and distances 114 of each auxiliary rotor 104 in response to control signals either received from the pilot or operator of the AV 100. For example, if the pilot or operator provides a command for the AV 100 to move left without changing attitude, the control system 110 may increase the angles 116 associated with some of the auxiliary rotors 104 such that the AV 100 moves in the left direction without changing attitude.

The slung load 106 may be an optional load that is being carried by the AV 100. The slung load 106 is described further below.

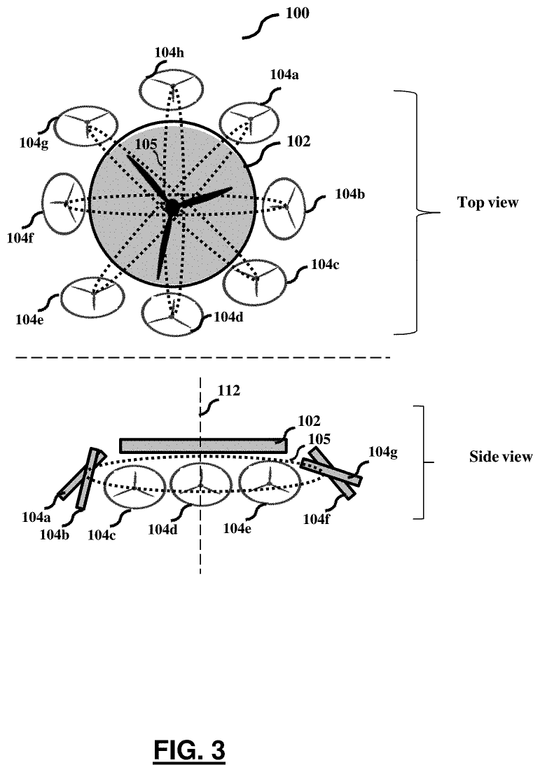

Continuing to FIG. 3, an AV 100 having 8 auxiliary rotors 104 (i.e., auxiliary rotors 104a-104h) is shown. The AV 100 of FIG. 3 may be substantially similar to the AV of FIG. 1 in that all of the auxiliary rotors 104 are arranged along the body 105 of the AV 100. Each auxiliary rotor 104 may be mounted to the body 105 of the AV at a distance 114 from the primary rotor 102. As can be seen in the side view of FIG. 3, each auxiliary rotor 104 may be adjustably mounted to the body 105 such that an angle 116 between the auxiliary rotor 104 and the center line 112 of the body 105 and/or the primary rotor 102 is adjustable to control the direction of the thrust exerted by the auxiliary rotor 104.

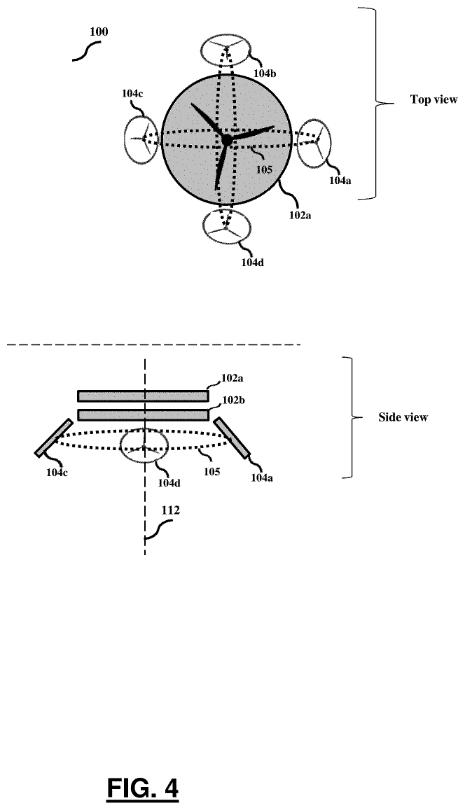

Continuing to FIG. 4, an AV 100 having 4 auxiliary rotors 104 (i.e., auxiliary rotors 104a-104d) and two primary rotors 102 (i.e., the primary rotors 102a and 102b) is shown. As can be seen in the side view, the primary rotors 102 are stacked on top of each other such that the primary rotor 102a is above the primary rotor 102b. As will be described further below, the rotation speeds of the primary rotors 102a and 102b may be synchronized to control one or both of a beat frequency or sound emitted from the AV 100 and a yaw of the AV 100. Depending on the embodiment, the primary rotors 102a and 102b may be connected to each other and the body 105 by a fixed stator vane along the center line 112. Other methods may be used. Each auxiliary motor 104 may have an adjustable (or fixed) angle 116 and may be located at a distance 114 from the centerline 112.

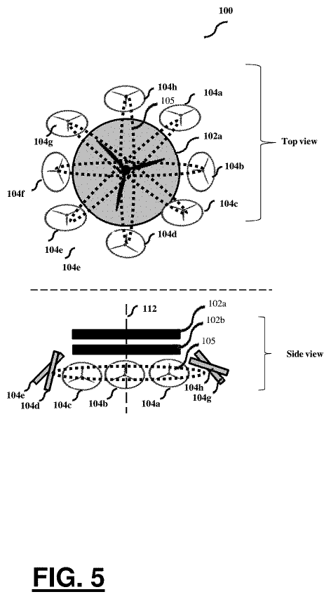

Continuing to FIG. 5, an AV 100 having 8 auxiliary rotors 104 (i.e., auxiliary rotors 104a-104h) and two primary rotors 102 (i.e., the primary rotors 102a and 102b) is shown. The AV 100 of FIG. 5 may be substantially similar to the AV 100 of FIG. 4 (including two primary rotors 102) but with four additional auxiliary rotors 104.

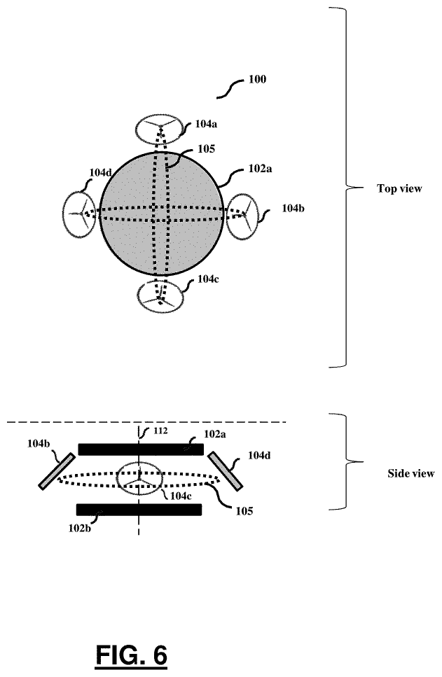

Continuing to FIG. 6, an AV 100 having 4 auxiliary rotors 104 (i.e., auxiliary rotors 104a-104d) and two primary rotors 102 (i.e., the primary rotors 102a and 102b) is shown. The AV 100 of FIG. 6 may be substantially similar to the AV 100 of FIG. 4 in that the AV has four auxiliary rotors 104 (i.e., auxiliary rotors 104a-d) and two primary rotors 102 (i.e., primary rotors 102a and 102b). However, as can be seen in the side view, the primary rotors 102 are placed on opposite sides of the body 105. For example, the primary rotor 102a is mounted on top of the body 105 while the primary rotor 102b is mounted on the bottom of the body 105.

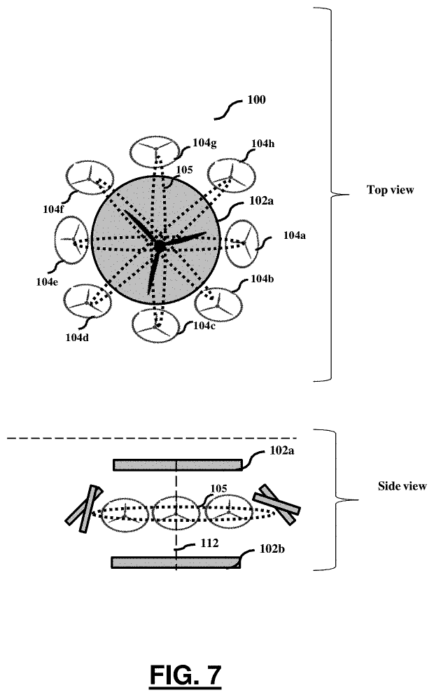

Continuing to FIG. 7, an AV 100 having 8 auxiliary rotors 104 (i.e., auxiliary rotors 104a-104h) and two primary rotors 102 (i.e., the primary rotors 102a and 102b) is shown. The AV 100 of FIG. 7 may be substantially similar to the AV 100 of FIG. 6 in that the AV has two primary rotors 102 (i.e., primary rotors 102a and 102b) located on opposite sides of the body 105.

The various embodiments of the AV 100 illustrated in FIG. 1-7 may have some or all of the following features. In an embodiment, the at least one primary rotor 102 and/or the one or more auxiliary rotors 104 may have a combined thrust vector that has a variable orientation with respect to the body 105 of the AV 100. The at least one thrust component may be utilized to control a change in movement of the AV 100 with respect to a world coordinate system. In an embodiment, the one or more auxiliary rotors 104 may be arranged on the body 105 to control roll, pitch and yaw of the AV 100 via the control system 110. In an embodiment, the one or more auxiliary rotors 104 may be arranged at the particular angle 116/different angle 116 to each other so as to produce a combined thrust in different directions with respect to the body 105 of the AV 100. In an embodiment, the angles 116 of the auxiliary rotors 104 may provide a vertical thrust component for use in maneuvering to counteract disturbances/movement on a slung load 106/payload and a horizontal thrust component for counter-torque to offset a drag torque produced by the primary rotor 102 to counteract disturbances/movement on a slung load or payload. In an embodiment, a vector value associated with the vertical thrust component of the primary rotor 102 may be changed due to interaction of the one or more primary rotor 102 with one or more auxiliary rotors 104.

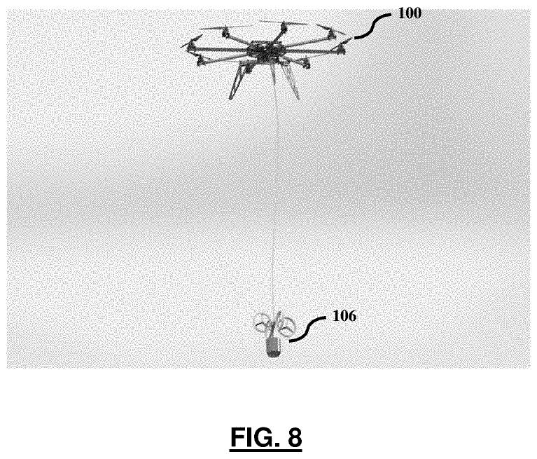

FIG. 8 is an illustration of an example AV 100 with a slung load/payload 106. Returning of FIG. 2, the control system 110 enabling changes in attitude of the AV 100 along with the slung load/payload 106. The control system 110 further enables changes in a position of the AV 100 with respect to a world geographical location. The control system 110 further provide forces and movements to counteract external forces and movements experienced by the AV 100 such as gravity, wind, touch etc. In an embodiment, the movement comprises enabling changes in a structure of the AV 100 such as changing one or more angles 116 or distances 114. In an embodiment, the movement comprises enabling changes in attitude of the AV 100.

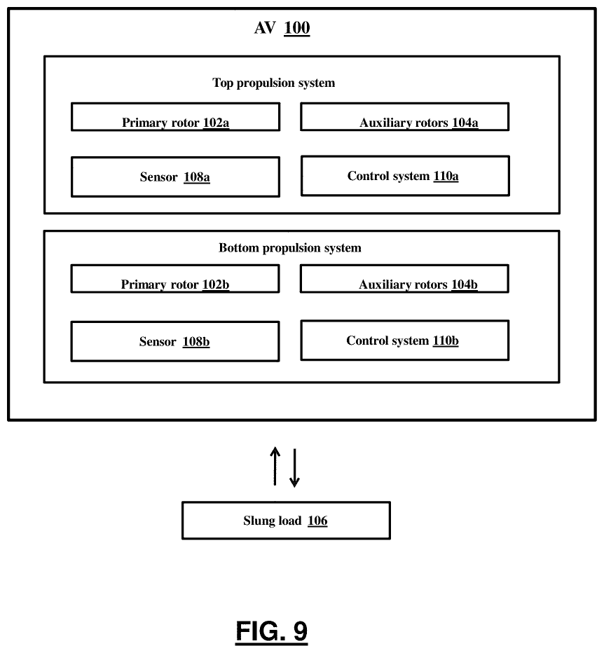

With reference to FIG. 9, is an illustration of an AV 100 that includes a top propulsion system and a bottom propulsion system. Examples of such an AV 100 include the AVs 100 illustrated in FIGS. 6 and 7. As shown in FIG. 9, the top propulsion system includes a primary rotor 102a, auxiliary rotors 104a, sensor 108a, and a control system 110a. Similarly, the bottom propulsion system includes a primary rotor 102b, auxiliary rotors 104b, sensor 108b, and a control system 110b. The top propulsion system may be mounted onto the top of the body 105 and the bottom propulsion system may be mounted to the bottom of the body 105. The AV 100 may be in communication with a slung load 106 being carried by the AV 100 by a string, rope, or wire, for example.

The senor 108b (or alternatively the sensor 108a) may be used by the control system 110b (or control system 110a) for estimating a position of the string, a velocity of the string, an acceleration of the string, a position of the slung load 106, a velocity of the slung load 106, and/or an acceleration of the slung load 106. The control system 108b may further estimate one or more forces on the string and a direction on the string.

The control system 110 (110a or 110b) may be configured to estimate a counter force to be exerted on the slung load 106 based on the estimated position of the string, estimated velocity of the string, estimated acceleration of the string, estimated position of the slung load 106, estimated velocity of the slung load 106 and/or estimated acceleration of the slung load 106, estimated forces on the string, and estimated direction of the string. The counter force may be exerted on the slung load 106 such that the slung load 106 remains relatively stationary relative to the AV 100. Any method for calculating a counter force may be used. The counterforce may have a direction and a magnitude.

After calculating the counterforce, the control system 110 (110a or 110b) may be further configured to send commands or instructions to one or more rotors or rotors attached to the slung load 106. The instructions may include the desired direction and magnitude for the slung load to apply using its one or more rotors or rotors. Example rotors and rotors can be seen on the slung load 104 illustrated in FIG. 8.

Returning to FIG. 9, the top propulsion system and bottom propulsion system may be synchronized to reduce the sound produced by the AV 100. In particular, the top propulsion system and bottom propulsion system may be synchronized to rotate at their individual RPMs such that the beat frequency (and the resulting harmonics) can be controlled. Beat frequency is often the manifestation of the difference of the frequencies of sounds produced by the individual blades. The individual RPMs and the beat frequencies are perceived as consonance or dissonance at varying loudness. The RPMs and their differences can be engineered to reduce the perception of loudness or the degree of consonance/dissonance with the intent to make the acoustic signature of the aircraft more comfortable. This provides only one frequency characteristics corresponding to the noise of the blade.

In another embodiment, the top propulsion system and the bottom propulsion system are synchronized at same revolutions per minute (RPM) using their respective sensors 108 to control the movement of the AV 100 in the intended direction with respect to the world geographical location.

In an embodiment, the top propulsion system includes the primary rotor 102a placed at the center line 112 of the AV 100, and one or more auxiliary rotors 104a mounted at the distance from the center of the AV 100. The one or more auxiliary rotors 104a exert lateral forces for position control without tilting the entire AV 100 and wherein the ratio of lateral forces exerted by the one or more auxiliary rotors 104a is varied in at least one of the vertical direction and the horizontal direction so that sustained side forces are exerted to move the AV 100 in multiple directions. The at least one primary rotor 102a and/or the one or more auxiliary rotors 104a have a combined thrust vector that has a variable orientation with respect to the body of the AV 100. The at least one thrust component is utilized to control a change in movement of the AV 100 with respect to a world coordinate system.

In an embodiment, the movement comprises enabling changes in attitude of the AV 100 along with the slung load 106/payload. In an embodiment, the movement comprises enabling changes in the position of the AV 100 with respect to the world geographical location. In an embodiment, the movement comprises providing forces to counteract external forces experienced by the AV 100. In an embodiment, the movement comprises enabling changes in the structure of the AV 100.

In an embodiment, the bottom propulsion system includes the primary rotor 102b placed at the center line 112 of the AV 100, and one or more auxiliary rotors 104b mounted at the fixed distance from the center of the AV 100. The one or more auxiliary rotors exerts lateral forces for position control without tilting the entire AV 100 and the ratio of lateral forces exerted by the one or more auxiliary rotors 104b is varied in at least one of the vertical direction and the horizontal direction so that sustained side forces are exerted to move the AV 100 in multiple directions. The at least one primary rotor 102b and/or the one or more auxiliary rotors 104b have a combined thrust vector that has a variable orientation with respect to the body 105 of the AV 100. The at least one thrust component is utilized to control a change in movement of the AV 100 with respect to a world coordinate system.

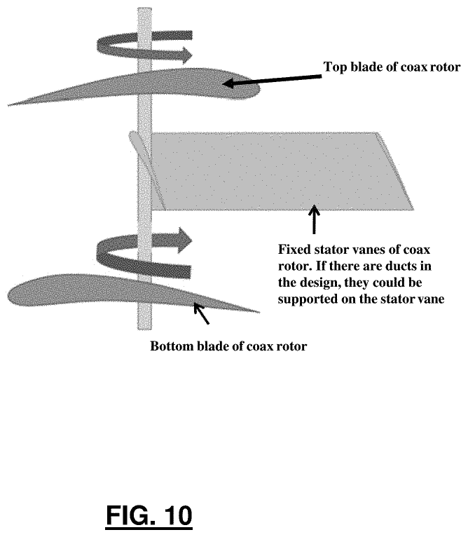

In an embodiment, the top propulsion system and the bottom propulsion system are rotated without coordinating their phase. In an embodiment, a fixed stator vane is arranged in between the top propulsion system and the bottom propulsion system. In an embodiment, the top propulsion system and the bottom propulsion system are arranged to synchronize the rotation of the AV 100 for controlling the yaw. An example fixed stator vane is illustrated with respect to FIG. 10

In an embodiment, a drag torque of one primary rotor 102 can be cancelled by the auxiliary rotors 104. This reduces the requirement for smaller set of rotors to counter the torque induced by the drag torque of the primary rotor 102.

In an embodiment, the change in position is controlled by both set of rotors, where the primary rotors 102 change the vertical position with respect to the geographical location, while the auxiliary rotors 104 change the position in the horizontal plane. The change in attitude is easy to control by the auxiliary rotors 104. However, there can be an embodiment where the primary rotors 102 also controls the attitude of the AV 100.

In an embodiment, the auxiliary rotors 104 are smaller as compared to primary rotors 120. The primary rotors 102 are kept bigger than the auxiliary rotors 104 as bigger rotors have higher propulsive efficiency. The auxiliary rotors 104 are faster to respond to control due to their smaller inertia. The external forces such as wind affect the position of the AV 100, which the auxiliary rotors 104 are more effective in counteracting than the larger primary rotors 102.

Returning to FIG. 9, the AV 100 is configured to rotate a top rotor (primary rotor 102a) and a bottom rotor (i.e., primary rotor 102b) at a selected revolution per minute (RPM). This can be done using the at least one sensor 108a or 108b, where the sensor 108 is configured to detect at least one of a position of the rotor and an accurate RPM of the rotor.

In general, when the top rotor and the bottom rotor rotate without coordinating their phase (the exact location of the blade in the 360 degree rotation), there are blade pass frequency noise from two different factors. One is due to the air accelerated by the top blade passing over the stator vanes if it exists. The second noise is due to the air accelerated by the top rotor passing over the blades of the bottom rotor. This is most often manifested as two different frequencies (noise). In the proposed systems, the system utilizes the sensor 108 (e.g., position sensor or the like) for each of the rotor to identify its time dependent location. The AV 100 may utilize a control logic of the control systems 110a or 110b for rotating the rotor such as to align the top rotor and the bottom rotor to coincide in a particular phase when the top rotor and the bottom rotor are over the fixed stator vane. This reduces the two main blades pass frequency noise to one. Synchronizing the rotation of the top rotor and the bottom rotor results in reduced yaw control authority since one degree of freedom has been reduced. This could be offset in one of many ways such as for example:

1) by providing yaw control from the auxiliary rotors 104, and

2) desynching the rotors 102 when the yaw authority is required.

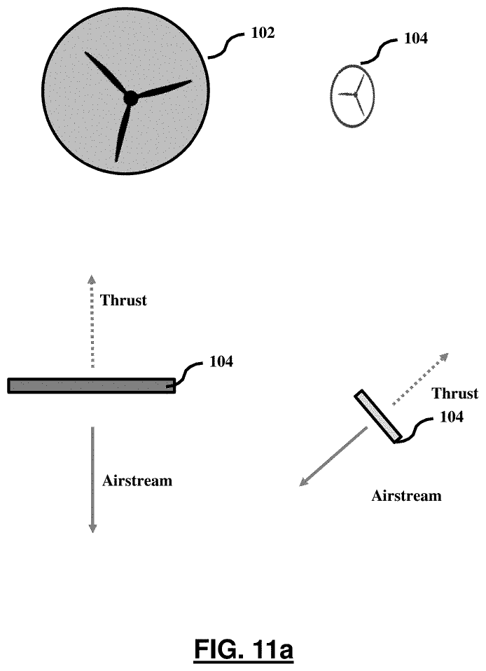

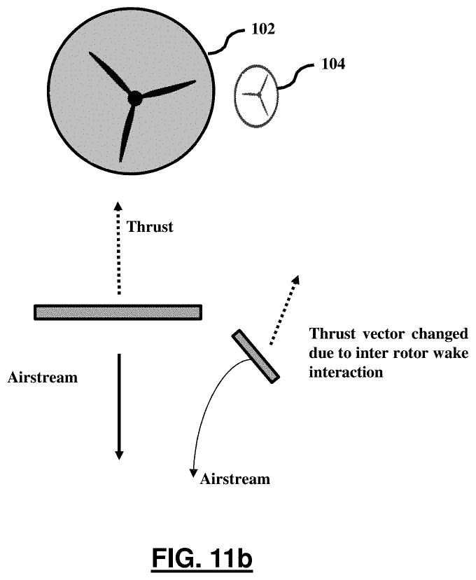

By placing the rotors at different positions, thrust vectors from individual rotors can be redirected. This has an effect of improving the overall efficiency of the AV 100 while providing the ability to have vectors directed in different directions. Examples are shown in the FIG. 11a to FIG. 11b.

In an embodiment, a duct is provided with the rotor. The duct adds the following advantages: 1) The duct provides improved propulsive efficiency; 2) The duct provides safety separation for the users from accessing the rotating blade and reducing the injury to the user; 3) The duct reduces the flapping of the rotor blades from external winds by reducing the amount of air directly interacting with the rotor blades; and 4) The ducted region between the top and the bottom propulsion regions may have inlet regions to allow air to enter the bottom propulsion system.

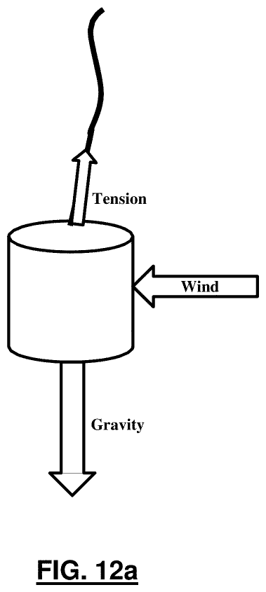

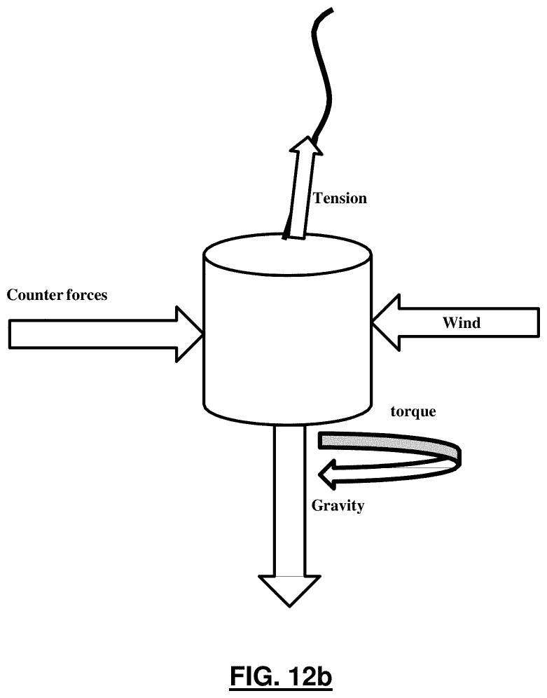

In an embodiment, the slung load 106/payload is hung from the AV 100 as shown in the FIG. 9. This mechanism is required for delivering payloads on the AV 100 when it is not feasible to land for either loading/unloading or both. The slung load 106 is usually susceptible to wind. The control system 110 may detect the movement of the slung load 106 and may make the AV 100 execute an explicit maneuver to counteract the disturbances/movements in the slung load 106. Further, in some embodiments, the AV 100 may provide a set of rotor configurations at the slung load 106 to reduce the effort required for the AV 100 to either reduce the effect of external disturbances such as wind or to accurately position the load with respect to a geographical coordinate system. FIGS. 12a and 12b illustrate forces action on the slung load 106. FIG. 11a-FIG. 11b illustrate a vertical thrust operation in different directions.

In an embodiment, the AV 100 can be utilized for transporting a payload from one location to the other. The AV 100 may also be utilized for monitoring and surveillance. In the proposed methods, the AV 100 utilizes monitoring while conducting payload transport or the AV 100 performs the payload transport while monitoring the object in a surveillance area. As shown in the FIG. 11a and the FIG. 11b, in an embodiment, multiple rotors are utilized to improve and redirect the thrust from the rotors' natural vector to a different vector due to wake interaction of the two different rotors airstreams. This could allow more thrust to be directed to the vertical direction to counteract gravity.

In an embodiment, the small rotors can exert lateral forces for position control without tilting the entire AV 100 to move to either side for short distances as shown in the FIG. 1, for example. In another embodiment, the small auxiliary rotors at two different angles can exert lateral forces for position control without tilting the entire AV 100. By varying the ratio of the forces exerted by the auxiliary rotors 104 in the vertical and horizontal direction (e.g., by changing the angles 116), sustained side forces can be exerted to move the vehicle in multiple directions. The small auxiliary rotors 104 can exert lateral forces for position control without tilting the entire vehicle to move to either side for short distances. In addition, the auxiliary rotors 104 may be used to move the AV 100 in either the vertical or horizontal direction while the UAV 100 is intentionally tilted or holding a roll, pitch, or yaw. The auxiliary rotors 104 may further allow the UAV to land on an incline.

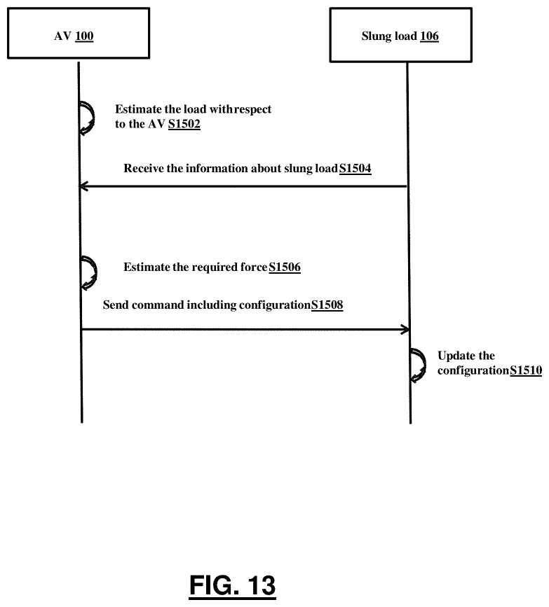

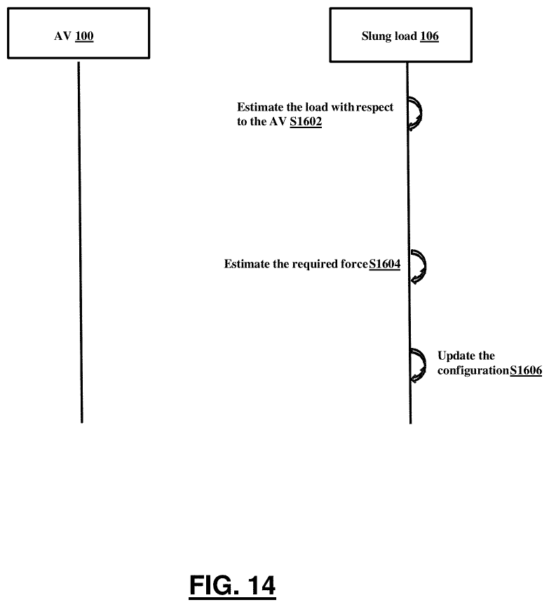

FIG. 13 and FIG. 14 are sequence diagrams illustrating various operations for stabilizing the slung load 106, according to embodiments as disclosed herein. As shown in the FIG. 13, at S1502, the AV 100 estimates the load with respect to the AV using the sensor 108. At S1504, the AV 100 receives the information about the slung load 106 using the sensor 108. At S1506, the AV 100 estimates the required force using the control system 110. At S1508, the AV 100 sends command to control the rotors of the rotors attached to the slung load and reduce the effort required for the AV 100 to reduce the effect of external disturbances such as wind, or to accurately position the load with respect to the world coordinate system. At S1510, the slung load 106 updates the configuration.

As shown in the FIG. 14, At S1602, the slung load 106 estimates the load with respect to the AV 100. At S1604, the slung load 106 estimates the required force. At S1606, the slung load 106 updates the configuration.

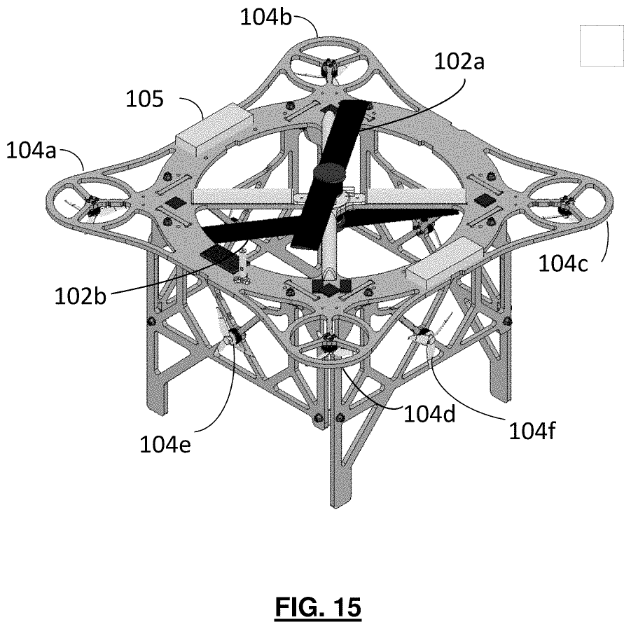

FIG. 15 is an illustration of an exemplary AV 100. The AV 100 of FIG. 15 may be a manned AV in that it is controlled by a pilot or operator. Alternatively, the AV 100 may be unmanned in that it is controlled by a computer. As shown, the AV 100 includes a body 105. The body 105 may be constructed from a lightweight material such as aluminum or plastic. Other materials may be used. Note that the configuration of the body 105 shown in FIG. 15 is for illustrative purposes only and is not meant to limit the AV 100 to the body 105 shown.

The AV 100 includes two primary rotors 102 mounted to the body 105. As shown the primary rotors 102 include a primary rotor 102a that is mounted on top of the body 105, and a primary rotor 102b mounted below the primary rotor 102b within the body 105 of the AV 100. Other configurations of primary rotors 102 may be used.

The AV 100 further includes a first set of auxiliary rotors 104 and a second set of auxiliary rotors 104. The first set of auxiliary rotors 104 include the auxiliary rotor 104a, the auxiliary rotor 104b, the auxiliary rotor 104c, and auxiliary rotor 104d. The auxiliary rotors 104 in the first set of auxiliary rotors are mounted to the top of the body 105 at a same angle 116 as the primary rotors 102. Thus, any thrust forces associated with these auxiliary rotors 104 are directed in the same direction as thrust forces associated with the primary rotors 102 (e.g., the vertical direction). Note that the AV 100 is not limited to four auxiliary rotors 104 in the first set of auxiliary rotors. For example, embodiments may have more or fewer auxiliary rotors 104 in the first set of auxiliary rotors.

The second set of auxiliary rotors 104 includes the auxiliary rotors 104e and 104f each mounted to a side of the body 105. The second set of auxiliary rotors may further include two additional auxiliary rotors 104 mounted to the sides of the body 105 that are not visible in the FIG. 15 due to the perspective of the rendering. Note that the AV 100 is not limited to four auxiliary rotors 104 in the second set of auxiliary rotors. For example, embodiments may have more or fewer auxiliary rotors 104 in the second set of auxiliary rotors.

The auxiliary rotors 104 in the second set of auxiliary rotors are each mounted to the body 105 of the AV 100 at an angle 116 with respect to the primary rotors 102 that is different than the angle 116 used to mount the auxiliary rotors 104 in the first set of auxiliary rotors. For example, the auxiliary rotor 104e is mounted to the body 105 at an angle 116 of 90 degrees with respect to the primary rotors 102, while the auxiliary rotor 104a is mounted to the body 105 at an angle 166 of 0 degrees with respect to the primary rotors 102. Other angles 116 may be used. Depending on the embodiment, the angles 116 may be fixed or may be adjustable.

As may be appreciated, because the auxiliary rotors 104 of the second set of auxiliary rotors are mounted to the body 105 at an angle 116 of 90 degrees with respect to the primary rotors 102, any thrust forces associated with these auxiliary rotors 104 are directed in the horizontal direction. Accordingly, the AV 100 may selectively use the auxiliary rotors 104 in the second set to move the AV 100 within the horizontal plane. In particular, the auxiliary rotors 104 in the second set may be selectively used by the AV 100 to move the AV 100 in the horizontal plane without changing the attitude of AV 100 or causing the AV 100 to gain or lose altitude.

In addition, the AV 100 may use the auxiliary rotors 104 in the first set of auxiliary rotors and the auxiliary rotors 104 in the second set of auxiliary rotors to move the AV 100 in either the vertical or horizontal direction while the UAV 100 is intentionally tilted or holding a roll, pitch, or yaw.

The AV 100 may selectively use the auxiliary rotors 104 in the first set of auxiliary rotors to independently move the AV 100 in the vertical plane and may use the auxiliary rotors 104 in the second set of auxiliary rotors to independently move the AV 100 in the horizontal plane. As may be appreciated this is an improvement over prior art AVs that require the AV to tilt or first move in the vertical plane to facilitate movement in the horizontal plane.

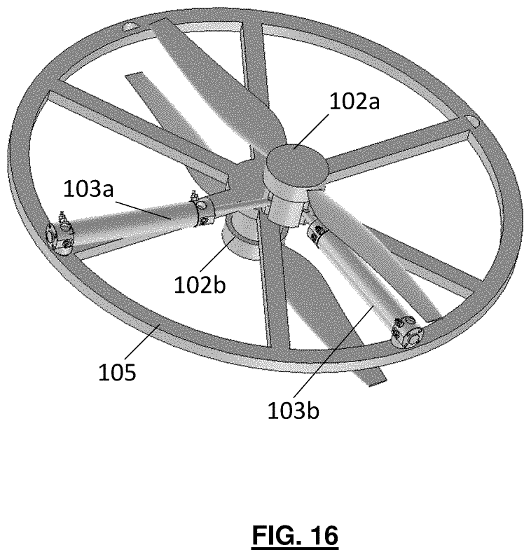

FIG. 16 is an illustration of an exemplary AV 100. The AV 100 of FIG. 16 may be a manned AV in that it is controlled by a pilot or operator. Alternatively, the AV 100 may be unmanned in that it is controlled by a computer. As shown, the AV 100 includes a body 105. The body 105 may be constructed from a lightweight material such as aluminum or plastic. Other materials may be used. Note that the configuration of the body 105 shown in FIG. 15 is for illustrative purposes only and is not meant to limit the AV 100 to the body 105 shown.

The AV 100 includes two primary rotors 102 mounted to the body 105. As shown the primary rotors 102 include a primary rotor 102a that is mounted on a top of the body 105, and a primary rotor 102b mounted below the primary rotor 102b on a bottom of the body 105. Other configurations of primary rotors 102 may be used.

The primary rotor 102a may be mounted to the body using translation means 103a and 103b that allow the primary rotor 102a to be moved or translated about the body 105 in the x and y direction in a plane that is parallel to the body 105. In the example shown, the translation means 103 are struts. However, other types of structures may be used such as linkages, lead screws, a direct drive, or any known method for linear motion. The translation means 103 may be controllable by a pilot or computer device while the AV 100 is flying, and may allow for an enhance controllability of the AV 100.

In one embodiment, only the primary rotor 102a is mounted to the body 105 using the translation means 103, while the primary rotor 102b is directly mounted to the center (or other location) of the body 105. Accordingly, in such an embodiment, only the primary rotor 102a may be moved. In another embodiment, both the primary rotor 102a and the primary rotor 102b may be mounted to the body 105 using the translation means 103.

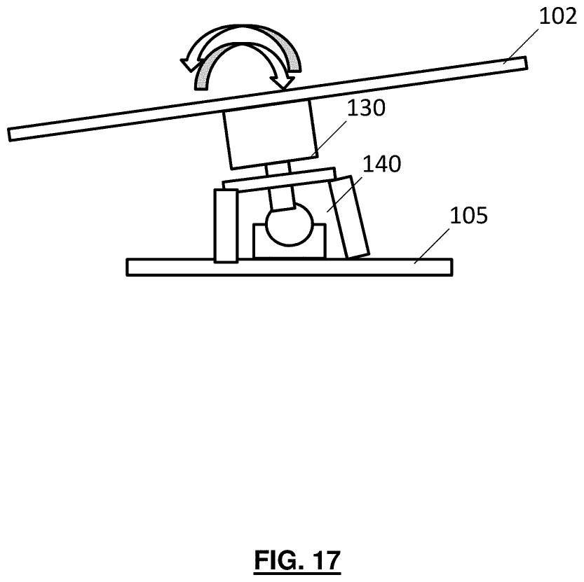

The primary rotors 102 may also be configured such that an angle between each primary rotor 102 and the body 105 (or translation means 103) can be changed or adjusted (i.e., tilted). FIG. 17 is an illustration of an example primary rotor 102 that can be tilted. As shown, the primary rotor 102 includes a motor 140 that is mounted to a tilting means 140 that is mounted to the body 105 (or translation means 103). In the example shown, the tilting means 140 is a ball joint, but other types of tilting means 140 may be used. Examples include a mechanical coupling, kinematic mount, hinge, or any other method or structure for angular positioning or linear actuation of an angular pivoting device.

Similar to the translation means 103, in one embodiment, only one of the primary rotors 102 may be mounted using a tilting means 140, while the other primary rotor 102 is mounted such that it cannot be tilted. In other embodiments, both primary rotors 102 may be mounted using tilting means 140. In still other embodiments, one primary rotor 102 may be mounted using just the translation means 103, while the other primary rotor 102 is mounted using just the tilting means 140.

The pilot or computer that in controlling the AV 100 may make adjustments to both the translation means 103 and the tilting means 140 while the AV 100 is flying. This may allow for an enhance controllability and maneuverability of the AV 100, especially when compared to previous AVs.

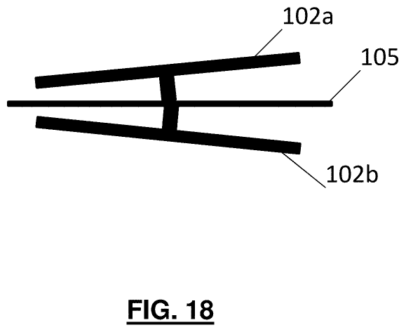

FIG. 18 is an illustration of an example AV 100 with primary rotors 102a and 102b connected to the body 105 using translation means 103 and tilting means 140. In the example shown, the primary rotor 102a and the primary rotor 102b have been slightly tilted by their respective titling means 140 while their translation means 103 remain centered around the center of the body 105.

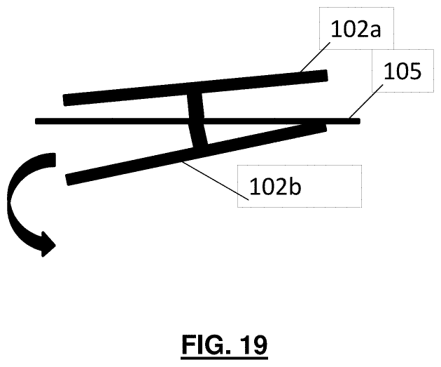

Continuing to FIG. 19, the primary rotor 102a remains tilted at the same angle as in FIG. 19, but the angle associated with the primary rotor 102b has been greatly changed by the tilting means 140 associated with the primary rotor 102b. The change in angle may be in response to the pilot of the AV 100 performing a particular movement.

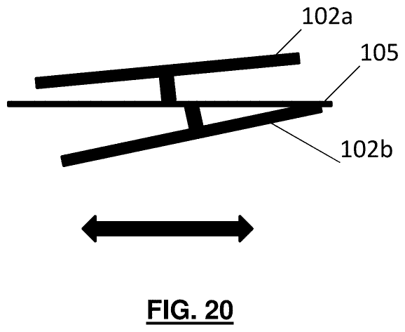

Continuing to FIG. 20, both the primary rotors 102a and 102b remain tilted at the same angle. However, the translation means 103 associated with the primary rotor 102b has moved the primary rotor 102b to the right. The change in position may be in response to the pilot of the AV 100 performing a particular movement.

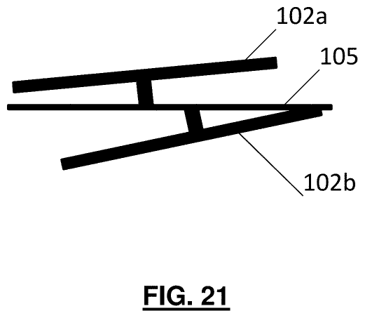

Continuing to FIG. 21, both the primary rotors 102a and 102b remain tilted at the same angle. However, the translation means 103 associated with the primary rotor 102b has moved the primary rotor 102b to the left. The change in position may be in response to the pilot of the AV 100 performing a particular movement.

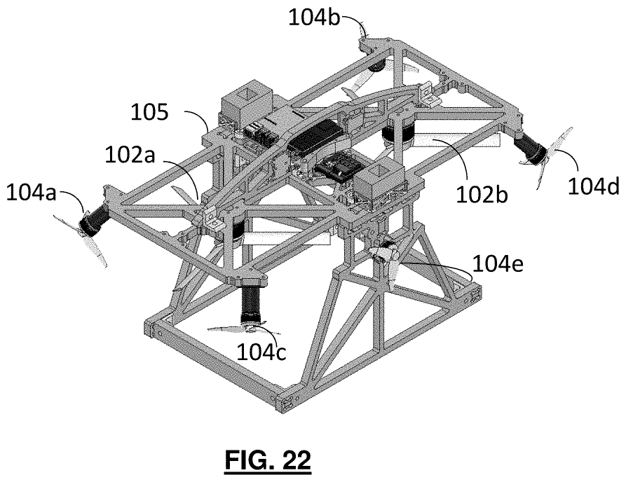

FIG. 22 is an illustration of an exemplary AV 100. The AV 100 of FIG. 22 may be a manned AV in that it is controlled by a pilot or operator. Alternatively, the AV 100 may be unmanned in that it is controlled by a computer. As shown, the AV 100 includes a body 105. The body 105 may be constructed from a lightweight material such as aluminum or plastic. Other materials may be used. Note that the configuration of the body 105 shown in FIG. 22 is for illustrative purposes only and is not meant to limit the AV 100 to the body 105 shown.

The AV 100 includes two primary rotors 102 mounted to the body 105. As shown the both primary rotors 102 are mounted next to each other on the body 105. Other configurations of primary rotors 102 may be used.

The AV 100 further includes a first set of auxiliary rotors 104 and a second set of auxiliary rotors 104. The first set of auxiliary rotors 104 include the auxiliary rotor 104a, the auxiliary rotor 104b, the auxiliary rotor 104c, and the auxiliary rotor 104d. The auxiliary rotors 104 in the first set of auxiliary rotors are mounted to the body 105 at an angle 116 such that the thrust from each of the auxiliary rotors 104 in the first set of auxiliary rotors has both a vertical and a horizontal component. Note that the AV 100 is not limited to four auxiliary rotors 104 in the first set of auxiliary rotors. For example, embodiments may have more or fewer auxiliary rotors 104 in the first set of auxiliary rotors.

The second set of auxiliary rotors 104 includes the auxiliary rotor 104e mounted to a side of the body 105. The second set of auxiliary rotors may further include an additional auxiliary rotors 104 mounted to the side of the body 105 that is not visible in the FIG. 22 due to the perspective of the rendering. Note that the AV 100 is not limited to two auxiliary rotors 104 in the second set of auxiliary rotors. For example, embodiments may have more or fewer auxiliary rotors 104 in the second set of auxiliary rotors.

The auxiliary rotors 104 in the second set of auxiliary rotors are each mounted to the body 105 of the AV 100 at an angle 116 with respect to the primary rotors 102 that is different than the angle 116 used to mount the auxiliary rotors 104 in the first set of auxiliary rotors. For example, the auxiliary rotor 104e is mounted to the body 105 at an angle 116 of 90 degrees with respect to the primary rotors 102. Other angles 116 may be used. Depending on the embodiment, the angles 116 may be fixed or may be adjustable.

As may be appreciated, because the auxiliary rotors 104 of the second set of auxiliary rotors are mounted to the body 105 at an angle 116 of 90 degrees with respect to the primary rotors 102, any thrust forces associated with these auxiliary rotors 104 are directed in the horizontal direction. Accordingly, the AV 100 may selectively use the auxiliary rotors 104 in the second set to move the AV 100 within the horizontal plane. In particular, the auxiliary rotors 104 in the second set may be selectively used by the AV 100 to more the AV 100 in the horizontal plane without changing the attitude of the AV 100 or causing the AV 100 to gain or lose altitude.

The UA 100 may selectively use the auxiliary rotors 104 in the first set of auxiliary rotors and the second set of auxiliary rotors to move the UA 100 in the horizontal plane. The UA 100 may selectively use the auxiliary rotors 104 in the first set of auxiliary rotors (and the primary rotors 102) to move the UA 100 in the vertical direction.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

FIG. 23 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 23, an exemplary system for implementing aspects described herein includes a computing device, such as computing device 2300. In its most basic configuration, computing device 2300 typically includes at least one processing unit 2302 and memory 2304. Depending on the exact configuration and type of computing device, memory 2304 may be volatile (such as random access memory (RAM)), non-volatile (such as read-only memory (ROM), flash memory, etc.), or some combination of the two. This most basic configuration is illustrated in FIG. 23 by dashed line 2306.

Computing device 2300 may have additional features/functionality. For example, computing device 2300 may include additional storage (removable and/or non-removable) including, but not limited to, magnetic or optical disks or tape. Such additional storage is illustrated in FIG. 23 by removable storage 2308 and non-removable storage 2310.

Computing device 2300 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 2304, removable storage 2308, and non-removable storage 2310 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1500. Any such computer storage media may be part of computing device 2300.

Computing device 2300 may contain communication connection(s) 2312 that allow the device to communicate with other devices. Computing device 2300 may also have input device(s) 2314 such as a keyboard, mouse, pen, voice input device, touch input device, etc. Output device(s) 2316 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

The present invention has been explained with reference to specific embodiments. For example, while embodiments of the present invention have been described as operating in connection with IEEE 802.11 networks, the present invention can be used in connection with any suitable wireless network environment. Other embodiments will be evident to those of ordinary skill in the art.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. An aerial vehicle comprising:
a body; and
a propulsion system, wherein the propulsion system comprises:
a primary rotor mounted at a center of the body; and
a plurality of auxiliary rotors, wherein each auxiliary rotor is mounted on the body at a distance from the center of the body and at an angle with respect to the primary rotor.

2. The aerial vehicle of claim 1, wherein the angle for each auxiliary rotor is adjustable.

3. The aerial vehicle of claim 1, wherein the distance for each auxiliary rotor is adjustable.

4. The aerial vehicle of claim 1, wherein the propulsion system further comprises a control system adapted to:
change the angle of one or more of the auxiliary rotors to change a direction of movement of the aerial vehicle.

5. The aerial vehicle of claim 4, wherein the control system is adapted to change the direction of movement of the aerial vehicle without changing the attitude or increasing or decreasing an altitude of the vehicle.

6. The aerial vehicle of claim 1, wherein the propulsion system further comprises a control system adapted to:
change a rotation speed of one or more of the auxiliary rotors to change a direction of movement of the aerial vehicle.

7. The aerial vehicle of claim 6, wherein the control system is adapted to change the direction of movement of the aerial vehicle without changing an attitude or increasing or decreasing an altitude of the aerial vehicle.

8. The aerial vehicle of claim 6, wherein the control system is further adapted to control a roll, pitch, and yaw of the aerial vehicle using the plurality of auxiliary rotors.

9. The aerial vehicle of claim 6, wherein the control system is further adapted to control an attitude of the aerial vehicle using the primary rotor.

10. The aerial vehicle of claim 1, wherein each of the auxiliary rotors is smaller than the primary rotor.

11. The aerial vehicle of claim 1, wherein the angle for each auxiliary rotor is fixed.

12. The aerial vehicle of claim 1, wherein the distance for each auxiliary rotor is fixed.

13. The aerial vehicle or claim 1, wherein the aerial vehicle is an unmanned aerial vehicle.

14. An aerial vehicle comprising:
a body; and
a propulsion system, wherein the propulsion system comprises:
a first primary rotor mounted at a center of the body;
a first plurality of auxiliary rotors, wherein each auxiliary rotor in the first plurality of auxiliary rotors is mounted on the body at a first angle with respect to the first primary rotor; and
a second plurality of auxiliary rotors, wherein each auxiliary rotor in the second plurality of auxiliary rotors is mounted on the body at a second angle with respect to the first primary rotor.

15. The aerial vehicle of claim 14, wherein the first angle and the second angle are different.

16. The aerial vehicle of claim 14, further comprising a second primary rotor mounted at the center of the body.

17. The aerial vehicle of claim 14, wherein the propulsion system further comprises a control system adapted to:
change a direction of movement of the aerial vehicle using the first plurality of auxiliary rotors or the second plurality of auxiliary rotors.

18. The aerial vehicle of claim 17, wherein the control system is adapted to change the direction of movement of the aerial vehicle without changing an attitude of the aerial vehicle or increasing or decreasing an altitude of the aerial vehicle.

19. The aerial vehicle of claim 14, wherein each of the auxiliary rotors is smaller than the primary rotor.

20. An aerial vehicle comprising:
a support structure;
a first propulsion system mounted on a top of the support structure; and
a second propulsion system mounted on a bottom of the support structure, wherein a first rotation speed of the first propulsion system and a second rotation speed of the second propulsion system are synchronized to control a sound of the aerial vehicle.
